(19) United States
(12) Patent Application Publication
(10) Pub. No.: US 2013/0065193 A1
(43) Pub. Date: Mar. 14, 2013

(54) Method for producing an orthodontic arch or retaining arch, device for performing said method, resulting orthodontic arch or retaining arch, and orthodontic appliance comprising same

(71) Applicants: Patrick Curiel, Neuilly (FR); William Ayache, Nueilly Sur Seine (FR); Philippe Salah, Paris (FR)

(72) Inventors: Patrick Curiel, Neuilly (FR); William Ayache, Nueilly Sur Seine (FR); Philippe Salah, Paris (FR)

(73) Assignee: H 32, Paris (FR)

(21) Appl. No.: 13/698,603

(22) PCT Filed: May 16, 2011
(86) PCT No.: PCT/FR11/51091

§ 371 Date: Nov. 16, 2012

(30) Foreign Application Priority Data
May 17, 2010 (FR) 1053778

(51) Int. Cl. A61C 7/20; B21C 51/00

(52) U.S. Cl. 433/20; 72/166; 72/17.3

(57) ABSTRACT

The invention relates to a method for producing a bent orthodontic arch or a bent retaining arch for orthodontic treatment, comprising the bending of portions of a metal wire. The invention is characterised in that it comprises the use of an apparatus of the type intended for the production of springs, comprising bending tools and means allowing the continuous movement of the wire to be bent. The invention also relates to the device used to perform the aforementioned method, to the resulting orthodontic arch or retaining arch and to an orthodontic appliance comprising same.

The invention concerns orthodontic braces, and in particular the fabrication of orthodontic braces intended to exert a force on the teeth of a patient that are initially wrongly positioned in order to place them in a corrected position, and the fabrication of contention wires intended to maintain the teeth in a corrected position after an orthodontic treatment.

Orthodontic braces for correcting the position of the teeth of the dental arch of a patient conventionally include:
at least one orthodontic wire, in other words a metal wire exerting on the teeth a force tending to move them from their initial unsatisfactory position, called the “wrong position”, to a final satisfactory position, called the “corrected position”; and
a series of brackets each provided with at least one groove for receiving a portion of the orthodontic wire; these brackets are individually fixed to the teeth of the patient in a particular position enabling the orthodontic wire to transfer to the teeth the forces necessary to move them from the wrong position to the corrected position during the treatment.

Usually one or more orthodontic wires are used, combined with a single series of brackets each including one or more grooves.

A distinction exists between vestibular orthodontic techniques in which the brace is disposed on the anterior face of the teeth and lingual techniques in which the brace is disposed on the posterior face of the teeth.

Lingual orthodontic techniques, which have the esthetic advantage that the brace is practically invisible from the outside, began to be developed around 1970. However, at the time they relied on entirely manual design and fabrication of the braces and their use was highly complex. This is because an important element in the success of the treatment is the correct positioning of the bracket and its groove on the tooth, because this positioning determines the orientation of the forces that are imposed on the corresponding tooth and thus the orientations of the tooth in various directions in space when it is in the final corrected position. This positioning is much more difficult to achieve with the lingual technique than with the labial or vestibular technique (in which the brace is disposed on the anterior face of the teeth), because of the marked angulation of the posterior faces of the teeth. This angulation means that a slight error in the positioning of the bracket may reposition the groove incorrectly, thus rendering the brace incapable of providing the required correction of the position of the tooth.

Information technology techniques have brought major improvements through facilitating the design of individualized orthodontic braces specific to each patient.

In one prior art technique, there may be designed on an individualized basis an assembly formed on the one hand by the virtual image of a base for fixing to the tooth, designed digitally from a computer image of the dental arch of the patient with the teeth in the wrong position produced from a model of the dental arch, and on the other hand from a virtual image of a bracket provided with a groove for inserting the orthodontic wire. This image is taken from a virtual library of brackets of predetermined shape. A bracket is then produced formed of a unique body resulting from the combination of these two images. An orthodontic wire is then designed that is intended to link the brackets and to bring the teeth of the patient into the corrected position. This corrected position is materialized by cutting each tooth out of the model of the dental arch and repositioning it in the required corrected position to obtain a corrected representation of the dental arch known as a “set-up”. The set-up is then digitized, allowing computerized determination of the shape of the wire that will be necessary to produce the required correction. This wire inevitably has a complex shape, in particular because it consists of a multiple succession of straight portions and curved positions with different radii of curvature that may extend in two or three spatial dimensions to link the brackets.

The document WO-A-03/068099 is representative of the basic principles of such a technique.

Contention wires are simply glued to the posterior faces of the teeth that they must hold in position over a period of time. However, their precise shape must be determined and produced so that they can adapt perfectly to the configuration of the posterior faces of the teeth, the geometry of which is very complex and varies greatly from one patient to another.

Orthodontic wires and contention wires may be shaped manually using pliers from stainless steel or other metal wires the chemical and mechanical properties of which are compatible with this use. This manual shaping is obviously lengthy and requires of the person skilled in the art very close attention for the optimal shape of the wire to be obtained with satisfactory accuracy, which shape is often very complex, especially in the case of contention wires.

To alleviate this drawback, machines have been designed that are specifically dedicated to the fabrication of these orthodontic wires, examples of which are described in the documents U.S. Pat. No. B2-6,732,558 and US-A-2009/0199609. After the shape and dimensions of the wire to be produced have been stored in their control system, these tools are controlled by a computer. They simulate the action of the conventional manual pliers to impart to the wire its local curvatures that allow it to be inserted into the grooves of the brackets and exert on each tooth the force that will allow it to find its corrected position.

However, it is necessary for the portions of the wire present in the grooves to be straight when the tooth reaches its corrected position. These straight portions are therefore linked by curved parts, and it is these curved parts that are shaped by the machine so that they connect the straight portions, which are not necessarily all coplanar. This sometimes leads to producing very marked bends in the curved areas situated between two straight portions. In practice, a continuous curvature is not always seen in these areas, but angular bends instead. This tends to weaken the wire. Most importantly, however, during treatment, the wire must be able to slide in the grooves of the brackets to accompany the movement of the teeth about their rotation center and hence the movement of the brackets. When an angular bend reaches the entrance of a groove, the wire is immobilized there and can no longer continue to exercise its function. Manual correction of the shape of the wires is therefore necessary, which of course disturbs the positions of the straight portions of the wire relative to the grooves. The practitioner therefore does not have to correct only the shape of the wire at the bend that is preventing it from sliding, and in fact it is often the case that the whole of the wire must be completely reshaped.

What is more, this method is not reproducibly applicable to all types of metal used to produce the wire.

This problem also arises for orthodontic wires intended for vestibular braces, for which the accuracy of the positioning of the brackets and their grooves is less important than for lingual braces. In their case, there is a lower probability of being obliged to form bends blocking sliding of the wire in the grooves, although this risk nevertheless exists. The limitations on the materials used are the same as for lingual wires.

As for contention wires, their geometry must be obtained very accurately as they are held on the teeth only by gluing. They must therefore be perfectly shaped to adhere to the posterior face of the teeth that they hold in position.

The object of the invention is to propose a method of shaping orthodontic wires of complex shape having a succession of straight portions and curved portions and of shaping contention wires that is free of the drawbacks referred to above and is very easy to execute reliably, whatever metal is used.

To this end, the invention provides a method of fabricating a curved orthodontic wire or contention wire for orthodontic treatment by curving portions of a metal wire, characterized in that a machine intended for the fabrication of wound and/or curved parts is used for this fabrication, including curving tools and means for continuously feeding the wire to be curved.

In one variant of the invention at least one of the curving tools of the machine includes at one of its ends one or more substantially cylindrical studs against which the other tool or tools press the wire to confer the required local curvature on it, and computer control means for the machine storing a digitized image of the shape of the required orthodontic or contention wire.

The temperature of the portions of the wire to be curved may be adjusted.

In one variant of the invention:
a model is molded from an impression of the dental arch of the patient with the teeth in the wrong position;
the shape of the curved orthodontic wire that will be necessary to correct the position of the teeth is determined from this model and a digitized image is produced;
said digitized image is exported to the computer control means of the machine for fabricating wound and/or curved parts;
some of its portions are shaped by using said machine to curve a continuously moving metal wire to obtain said curved orthodontic wire.

The temperature of the portions of the wire to be curved may also be adjusted while they are being curved.

This adjustment of the temperature of the wire portions to be curved may be controlled to confer a temperature gradient on the portions undergoing the adjustment.

In one variant of the invention the shape of the curved orthodontic wire is determined by digitizing the impression of the dental arch with the teeth in the wrong position followed by production from this digitization of a virtual representation of the dental arch with the teeth in the corrected position, followed by computerized design based on said representation of the brace necessary to obtain said corrected position including said orthodontic wire.

In another variant of the invention the shape of the curved orthodontic wire is determined by preparing a set-up from said impression of the dental arch with the teeth in the wrong position, said set-up is digitized, after which the brace necessary for obtaining said corrected position including said orthodontic wire is computer-designed from said digitization.

In a further variant of the invention:
a model is molded from an impression of the dental arch of the patient with the teeth in the corrected position;
the shape of the curved contention wire that would be necessary to maintain the corrected position of the teeth is determined and a digitized image thereof is produced;
said digitized image is exported to the computer control means of the machine for fabricating wound and curved parts;
some of its portions are shaped by using said machine to curve a continuously moving metal wire to obtain said curved contention wire.

In one variant of the invention:
the shape of the contention wire is determined from the digitized image of a set-up produced during a previous orthodontic treatment;
the shape of the curved contention wire that would be necessary to maintain the corrected position of the teeth is determined and a digitized image of it is produced;
said digitized image is exported to the computer control means of the machine for fabricating wound and/or curved parts;
some of its portions are shaped by using said machine to curve a continuously moving metal wire to obtain said curved contention wire.

The invention also provides a device for the fabrication of a wound and/or curved part or a curved metal wire such as a curved orthodontic wire or a curved contention wire, including tools for curving a metal wire in continuous movement and computer control means of the device, the computer control means allowing storage of a digital image of the curved part or the curved wire that is required, characterized in that it includes means for adjusting the temperature of portions of the wire while they are being shaped.

Said means for adjusting the temperature of the portion of the wire may consist of an induction furnace placed on the path of the wire upstream of the wire curving tools.

These adjustment means may be adapted to confer a temperature gradient on the wire portions to which the adjustment relates.

The device may also include means for adjusting the temperature of at least one of the curving tools.

The device may include at least one tool including at one of its ends one or more substantially cylindrical studs against which the other tool or tools press the wire to confer upon it the required local curvature.

The invention further provides a curved orthodontic wire, characterized in that it was produced by the above method.

The invention further provides a curved contention wire, characterized in that it was produced by the above method.

The invention further provides an orthodontic brace, characterized in that it includes an orthodontic wire or a contention wire of the above type.

It will have been understood that the invention consists in shaping orthodontic wires and contention wires using particular devices initially intended to fabricate precision wound and curved parts, such as springs. These devices are controlled by a computer in which the shape to be conferred on the wire has been stored beforehand.

One nonlimiting example of such equipment particularly well suited to execution of this method is described in the document US-A-2009/0007619, for example and sold by the company WAFIOS under product codes FMU 0.7 to 2.7.

The basic principle of this equipment is to feed continuously with wire a machine provided with tools that grip the wire and confer the required local curvature on it by winding it around small rollers consisting of substantially cylindrical studs situated at the end of at least one of the tools. A combination of tools oriented in space allows the wire to be shaped in three dimensions if necessary. Instead of mainly producing turns by these deformations, as when shaping a spiral spring, in the context of the invention there is effected only a simple curvature of the wire in two or three dimensions of the portions of the wire where this is necessary, and the wire is left straight in the portions to constitute the straight portions intended to be inserted into the grooves of the brackets by allowing the wire to move tangentially to the rollers or away from the rollers. These machines also allow straight portions to be produced on the parts that they usually fabricate and their operating principle is not modified by their use in the context of the invention. They are computer controlled and to produce orthodontic wires and contention wires on these machines it suffices to program the software that controls them by storing therein a digitized image of the wire to be obtained. This digitized image may be obtained by means known in themselves, as described hereinafter.

Compared to conventional machines for shaping orthodontic wires, the use of a machine initially intended for fabricating wound and/or curved parts, designed in particular, but not exclusively, according to the principle that has been described, has the following advantage.

As stated, the conventional machines for shaping orthodontic wires that have been referred to merely reproduce mechanically the gestures of a technician who, using pliers, locally shapes the wires, with the risk of producing excessively angular bends that will then constitute obstacles to the proper sliding of the orthodontic wire in the grooves of the brackets. The machines for fabricating wound and/or curved parts, notably that described by way of preferred example, facilitate obtaining locally curved shapes free of such excessively angular bends.

In the conventional way, the parameters of the machine must be set to take account of the mechanical properties of the material employed. In this way, the control software is able to determine as a function of these properties and the speed at which the wire is fed what movements and what wire deformation forces are to be imposed on the shaping tools to obtain the required shape.

An advantageous modification that may be made to known machines for shaping wound and/or curved parts, with a view to fabricating orthodontic wires and contention wires, consists in adding to them a device for adjusting the temperature of the wire, for example by induction heating. This adjustment device imposes on the portion of the wire to be curved a given temperature different from, either lower than or, generally, higher than, ambient temperature. This proves particularly beneficial in the case of orthodontic wires in shape memory alloys, which are not usually employed to fabricate wound and/or curved parts but that may be used to fabricate orthodontic wires and contention wires. By imposing a given temperature on the wire during its deformation, the required curved shaped may be conferred on it reliably. Of course, the control software of the machine must then include a subroutine dedicated to controlling the heating means which takes into account the foreseeable evolution of the temperature of the wire between leaving the temperature adjustment means and reaching the place where it is deformed. This evolution may thus be caused by natural cooling by contact with the air as much as by contact with the tools and wire guide members. Standard modeling refined by means of experimental results make it easy for the person skilled in the art to produce such subroutines.

To refine the local adjustment of the shape of the wire, the means for adjusting its temperature may impart a temperature gradient to the portion to which this adjustment relates. This may be achieved by designing the induction furnace in the form of a succession of coils inside which the wire moves, for example, each of these coils being used or not during heating, at the choice of the operator.

This temperature adjustment device may be installed at any location on the path of the wire upstream of the location at which the wire is in contact with the tools for deforming it.

Such devices are not normally necessary if the standard materials such as stainless steel are treated and none are found on the usual installations for fabricating wound and/or curved parts, for example those based on the principle that has been described. However, adding to such installations a device for adjusting the temperature of the wire, such as an induction furnace, makes it possible to use shape memory alloys (such as nickel-titanium alloys) to fabricate non-standardized geometry orthodontic wires perfectly suited to the requirements of the patient.

It is important to note that shape memory alloys have become standard in lingual and vestibular orthodontic treatments. The invention makes it possible to excel in their use.

A method of the invention for fabricating orthodontic wires includes the following successive steps:
producing a model from an impression of the dental arch of the patient with the teeth in the wrong position;
digitizing said model;
computerized design of the brace that will be necessary to correct the position of the teeth by causing them to move from the wrong position of the initial model to a predetermined corrected position; this design may in particular be carried out after forming a representation of the dental arch with the teeth in said required position; this formation may be effected virtually, and thus entirely on the computer, from the digital image of the model of the dental arch of the patient or by digitizing a “set-up” produced from the model of the dental arch; during this design process, the shape of the orthodontic wire is determined that it would be necessary to use, in conjunction with the other components of the brace, to move the teeth into the target corrected position;
exporting the image of said wire into the control software of a machine for fabricating wound and/or curved parts and including tools for curving a wire, one of these tools including one or more substantially cylindrical studs onto which the wire may be pressed to confer on it the required local curvature;
shaping the wire by said machine by two-dimensional or three-dimensional curving of its portions intended to link straight portions intended to be inserted into the grooves of the brackets of the orthodontic brace; this shaping may optionally be preceded by bringing the portion of the wire to be curved to a temperature different from ambient temperature, for example by passing the wire into an induction furnace, especially when treating a shape memory alloy wire;
recovering the curved wire.

It may then be verified that the geometry of the curved wire obtained in this way conforms to that expected by digitizing its image and comparing it to the stored digital image of the wire that was used to program the fabrication equipment. If the wire is plane, the comparison may equally be effected by simply superposing the wire actually produced with a stored 1/1 scale printed image of the wire.

If a device for adjusting the temperature of the wire during curving thereof is used, there may equally be provision for adjusting the temperature of at least one of the tools of the curving equipment that are in contact with the wire, (notably by internal circulation of fluid or heating by the Joule effect), so as to bring it to a temperature equal to that of the wire, or closer to that temperature, that is not ambient temperature, so as to reduce the temperature gradients and thus make the curving of the wire reliable.

The method of the invention allows orthodontic wires to be obtained that are accurately locally curved in three dimensions in space (or to the first, second and third orders to use the terminology employed by orthodontists). Thus made to measure wires are obtained that are totally individualized and meet without constraint the practitioner's prescription.

The method of the invention applies to all materials routinely used to fabricate orthodontic wires: steel, TiMo, etc., and also to shape memory alloys such as NiTi alloys if there is added to the curving machine a device for adjusting the temperature of the wire during curving thereof, such as an induction furnace, disposed upstream of the curving tools.

The orthodontic wire resulting from the method of the invention may lie wholly within a plane or extend in three directions in space.

One of the advantages of the method of the invention is to guarantee excellent reproducibility over time of the geometry of the wire, independently of its material. It is therefore possible to replace the wire without difficulty during treatment of the patient, notably in the following two situations:
if the wire breaks;
if the orthodontic treatment is carried out in a number of steps: a first step is carried out during which the teeth are positioned in a relatively coarse manner by means of a first wire, after which, in subsequent steps, this wire is replaced by another wire or a succession of wires having exactly the same geometry but different tooth repositioning capabilities than the first wire, because of their materials and/or their cross-sections.

The description until now has mainly concerned the fabrication of orthodontic wires suited to the use of a lingual technique for correcting the position of the teeth. However, the invention may also apply in the same way to the fabrication of orthodontic wires used in the context of a vestibular technique, and thus applied to the anterior face of the teeth.

It is also possible to use the same technique to produce “contention” wires. Contention wires are intended to be glued, temporarily or definitively, at the end of treatment to the posterior faces of the teeth of the whole of the dental arch or of only a portion of the dental arch, to prevent the possibility of the teeth returning to an incorrect position after removing the brace. These contention wires are generally thinner than corrective orthodontic wires and are particularly difficult to shape well. Their cross-sections may also be diverse: circular, square, rectangular, etc., and they may be single-strand or braided multi-strand wires.

The invention enables them to be produced with no more problems than correction wires. The production method may be the same as that described for correction wires, except that the wire geometry that is introduced into the control software of the curving machine is determined only from the geometry of the dental arch with the teeth in the corrected position. The geometry of the contention wire is therefore determined on the basis of either a model made from an impression of the dental arch at the end of treatment or a set-up should the latter prove exactly conformed to the dental arch at the end of treatment.

1. A method of fabricating a curved orthodontic wire or contention wire for orthodontic treatment comprising:
curving portions of a metal wire using a machine intended for the fabrication of wound and/or curved parts is used for this fabrication, including curving tools and means for continuously feeding the wire to be curved.

2. The method as claimed in claim 1, characterized in that at least one of the curving tools of the machine includes at one of its ends one or more substantially cylindrical studs against which the other tool or tools press the wire to confer the required local curvature on it, and computer control means for the machine storing a digitized image of the shape of the required orthodontic or contention wire.

3. The method as claimed in claim 2, characterized in that the temperature of the portions of the wire to be curved is adjusted.

4. The method as claimed in claim 3, characterized in that the temperature adjustment is controlled so as to confer a temperature gradient on the portions of the wire undergoing the adjustment.

5. The method as claimed in claim 4 of fabricating a curved orthodontic wire, characterized in that:
a model is molded from an impression of the dental arch of the patient with the teeth in the wrong position;
the shape of the curved orthodontic wire that will be necessary to correct the position of the teeth is determined from this model and a digitized image is produced;
said digitized image is exported to the computer control means of the machine for fabricating wound and/or curved parts;
some of its portions are shaped by using said machine to curve a continuously moving metal wire to obtain said curved orthodontic wire.

6. The method as claimed in claim 5, characterized in that the shape of the curved orthodontic wire is determined by digitizing the impression of the dental arch with the teeth in the wrong position followed by production from this digitization of a virtual representation of the dental arch with the teeth in the corrected position, followed by computerized design based on said representation of the brace necessary to obtain said corrected position including said orthodontic wire.

7. The method as claimed in claim 6, characterized in that the shape of the curved orthodontic wire is determined by preparing a set-up from said impression of the dental arch with the teeth in the wrong position, said set-up is digitized, after which the brace necessary for obtaining said corrected position including said orthodontic wire is computer-designed from said digitization.

8. The method as claimed in claim 4 of fabricating a curved contention wire, characterized in that:
a model is molded from an impression of the dental arch of the patient with the teeth in the corrected position;
the shape of the curved contention wire that would be necessary to maintain the corrected position of the teeth is determined and a digitized image thereof is produced;
said digitized image is exported to the computer control means of the machine for fabricating wound and/or curved parts;
some of its portions are shaped by using said machine to curve a continuously moving metal wire to obtain said curved contention wire.

9. The method as claimed in claim 4 of fabricating a curved contention wire, characterized in that:
the shape of the contention wire is determined from the digitized image of a set-up produced during a previous orthodontic treatment;
the shape of the curved contention wire that would be necessary to maintain the corrected position of the teeth is determined and a digitized image of it is produced;
said digitized image is exported to the computer control means of the machine for fabricating wound and/or curved parts;
some of its portions are shaped by using said machine to curve a continuously moving metal wire to obtain said curved contention wire.

10. A device for the fabrication of a wound and/or curved part or a curved metal wire such as a curved orthodontic wire or a curved contention wire, including tools for curving a metal wire in continuous movement and computer control means of the machine, the computer control means of the device allowing storage of a digital image of the wound and/or curved part or the curved wire that is required, characterized in that it includes means for adjusting the temperature of portions of the wire while they are being shaped.

11. The device as claimed in claim 10, characterized in that said means for adjusting the temperature of portions of the wire consist of an induction furnace placed on the path of the wire upstream of the wire curving tools.

12. The device as claimed in claim 11, characterized in that the means for adjusting the temperature of the wire are adapted to confer a temperature gradient on the wire portions to which the adjustment relates.

13. The device as claimed in claim 12, characterized in that it also includes means for adjusting the temperature of at least one of the curving tools.

14. The device as claimed in claim 13, characterized in that it includes at least one tool including at one of its ends one or more substantially cylindrical studs against which the other tool or tools press the wire to confer upon it the required local curvature.

15. A curved orthodontic wire, characterized in that it was produced by the method as claimed in claim 7.

16. A curved contention wire, characterized in that it was produced by the method as claimed in claim 10.

17. An orthodontic brace, characterized in that it includes an orthodontic wire or a contention wire as claimed in claim 16.
